(19) United States
(12) Patent Application Publication
(10) Pub. No.: US 2026/0104111 A1
(43) Pub. Date: Apr. 16, 2026

(54) SIDE WALL SEAL FOR PIPING

(71) Applicant: Roof Goose Vent LLC, North Kingstown, RI (US)

(72) Inventor: Jack F. KING, JR., North Kingstown, RI (US)

(73) Assignee: Roof Goose Vent LLC, North Kingstown, RI (US)

(21) Appl. No.: 19/357,901

(22) Filed: Oct. 14, 2025

Related U.S. Application Data
(60) Provisional application No. 63/707,405, filed on Oct. 15, 2024.

(51) Int. Cl. F16L 5/02; E04C 2/52

(52) U.S. Cl. CPC F16L 5/02; E04C 2/526

(57) ABSTRACT

There is disclosed a side wall seal for piping comprising a cover for attachment to a side wall of a building and to cover a pipe(s) exiting from the building side wall and having an opening in the bottom through which the pipe(s) exit. The cover is molded having a rigid plastic frame portion overmolded with a thermoplastic elastomer and the remainder of the cover comprising the thermoplastic elastomer. The cover may include a bottom member for attaching to the bottom of the cover, the bottom member being made of a thermoplastic elastomer. The side wall seal may further include one or more spacers placed between the cover and the building side wall to provide a vertical surface when the side wall of the building has an uneven surface such as lap siding.

### RELATED APPLICATION

This application claims the benefit of U.S. Provisional Application Ser. No. 63/707,405, filed Oct. 15, 2024, entitled “Side Wall Seal For Piping,” which is incorporated herein by reference in its entirety.

### FIELD OF THE INVENTION

The present invention relates to a side wall seal for piping. More specifically, the invention relates to a side wall seal for piping for pipes exiting a building at a right angle to the side wall.

### BACKGROUND OF THE INVENTION

Pipes exit the side wall of buildings and require a water resistant seal. Such pipes may be for linesets, e.g. for an air conditioning system; for a gas line; for a drain line; or for similar pipes exiting the side wall of a building. The seal may be for a single pipe or for multiple pipes.

Seals for piping are known in the prior art such as the TSS575 Airex Titan GS30 ¾″ Gray Lineset Wall Seal System comprising a rectangular box covering an opening in a building side wall through which a pipe extends and having a rubber gasket fitted over the pipe and against the box to provide a seal. This seal includes a number of parts and cannot be used in tight quarters because of its size.

While the prior art seals may provide some benefits, improvement is possible, including providing a water resistant seal which is inexpensive and easy to use. The present invention addresses these issues.

### SUMMARY OF THE INVENTION

A primary object of the invention is to provide a side wall seal for piping.

Another primary object of the invention is to provide a water resistant seal for piping exiting from a side wall of a building, including for a single pipe or for multiple pipes.

Another primary object of the invention is to provide a side wall seal for piping which is water resistant and useful for pipes exiting a building side wall at a right angle.

Another primary object of the invention is to provide a side wall seal for piping which is water resistant and which may be used for retrofit installation for existing pipes or for pipes in new construction.

Another primary object of the invention is to provide a side wall seal for piping which is water resistant and is made of plastic and overmolded with a flexible rubber and is minimally sized to fit into tight places.

The invention is directed to a side wall seal for piping comprising a cover for attachment to a side wall of a building and to cover a pipe(s) exiting from the building side wall and having an opening in the bottom through which the pipe(s) exit. The cover is molded having a rigid plastic frame portion overmolded with a thermoplastic elastomer and the remainder of the cover comprising the thermoplastic elastomer. The cover may include a bottom member for attaching to the bottom of the cover, the bottom member being made of a thermoplastic elastomer. The side wall seal may further include one or more spacers placed between the cover and the building side wall to provide a vertical surface when the side wall of the building has an uneven surface such as lap siding.

These primary and other objects of the invention will be apparent from the following description of the preferred embodiments of the invention and from the accompanying drawings.

### BRIEF DESCRIPTION OF THE DRAWINGS

The following detailed description of the specific non-limiting embodiments of the present invention can be best understood when read in conjunction with the following drawings, where like structures are indicated by like reference numbers.

Referring to the drawings:

FIG. 1A is a perspective front and side view of the side wall seal for piping of the present invention.

FIG. 1B is a perspective rear and side view of the side wall seal of FIG. 1A.

FIG. 1C is a side view of the side wall seal of FIG. 1A.

FIG. 1D is a top view of the side wall seal of FIG. 1A.

FIG. 1E is a front view of the side wall seal of FIG. 1A.

FIG. 2A is a perspective exploded view of side wall seal of FIG. 1A.

FIG. 2B is another perspective exploded view of the side wall seal of FIG. 2A.

FIG. 2C is a top exploded view of the side wall seal of FIG. 2A.

FIG. 2D is a front exploded view of the side wall seal of FIG. 2A.

FIG. 3A is a perspective front and bottom view of the cover of the side wall seal of FIGS. 1A and 2A.

FIG. 3B is a perspective front and side view of the cover of FIG. 3A.

FIG. 3C is a back view of the cover of FIG. 3A.

FIG. 3D is a front view of the cover of FIG. 3A.

FIG. 3E is a bottom view of the cover member of FIG. 3A.

FIG. 4A are perspective, top, side and bottom views of a first spacer of FIG. 2A.

FIG. 4B are perspective, top, side and bottom views of a second spacer of FIG. 2A.

FIG. 4C are perspective, top, side and bottom views of a third spacer of FIG. 2A.

FIG. 5A is a perspective view of the frame of the cover of the side seal of FIG. 2A.

FIG. 5B is a side view of the frame of FIG. 5A.

FIG. 5C is a top view of the frame of FIG. 5A.

FIG. 5D is a front view of the frame of FIG. 5A.

FIG. 6A is a perspective bottom view of the bottom cover of FIG. 2A.

FIG. 6B is a perspective top view of the bottom cover of FIG. 6A.

FIG. 6C is a bottom view of FIG. 6A.

FIG. 6D is a side view of FIG. 6A.

FIG. 6E is a top view of FIG. 6A.

FIG. 7A is a front and side perspective view of the side wall seal of FIG. 1A attached to an uneven surface of a building wall.

FIG. 7B is a front view of FIG. 7A.

FIG. 7C is a side view of FIG. 7A.

FIG. 8A is a front and side perspective view of the side wall seal of FIG. 1A attached to an even surface of a building wall.

FIG. 8B is a front view of FIG. 8A.

FIG. 8C is a side view of FIG. 8A.

### DETAILED DESCRIPTION OF THE PREFERRED EMBODIMENTS

The invention is directed to a side wall seal for piping. Specifically, a water resistant seal is required for piping exiting from a side wall from a building, including for a single pipe or for multiple pipes. The device is useful for pipes exiting a building side wall at a right angle to the side wall. The device may be used for retrofit installation for existing piping or for piping in new construction installation. The seal, including the cover, bottom cover, and spacers, is made in part of a rigid plastic such as, but not limited to, polypropylene to provide a frame portion of the seal which is overmolded with a flexible rubber such as, but not limited to, a thermoplastic elastomer such as Santoprene®. The seal is minimally sized to fit into tight spaces.

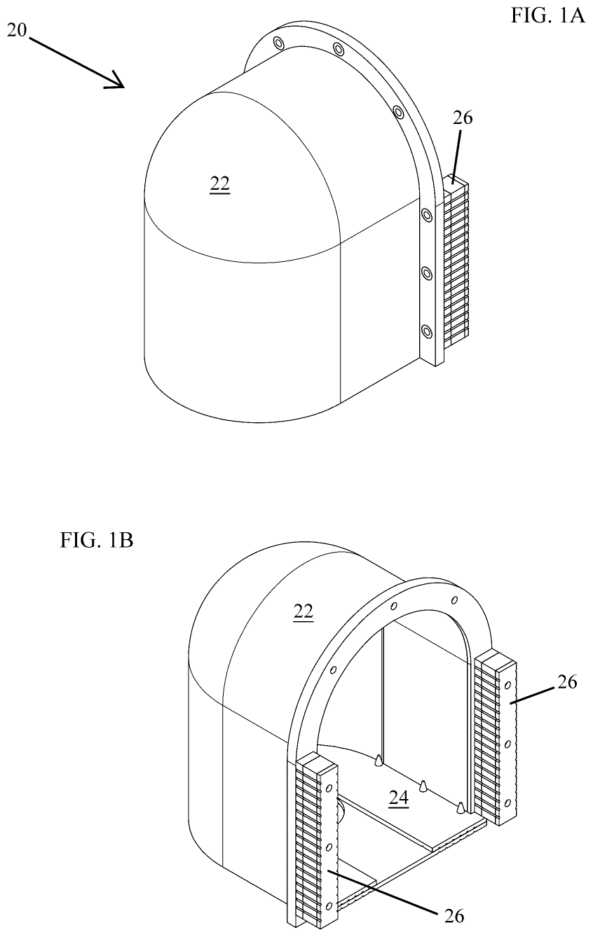

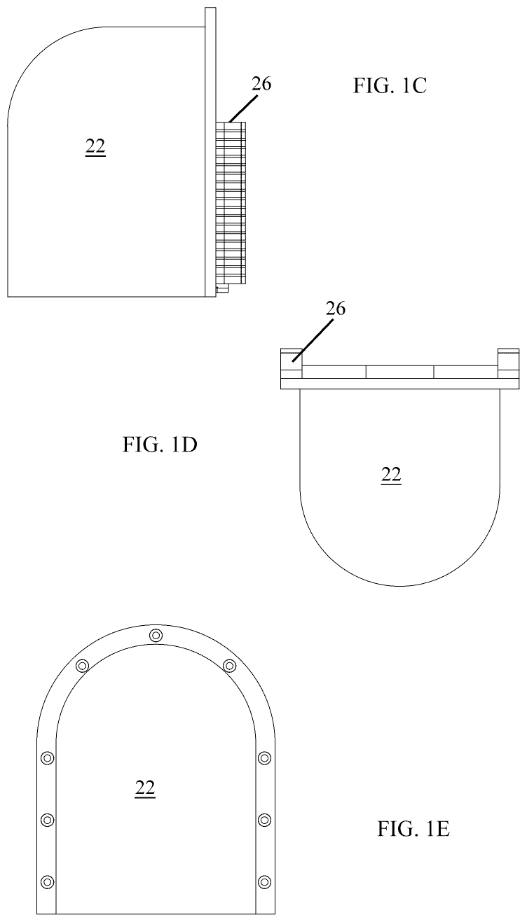

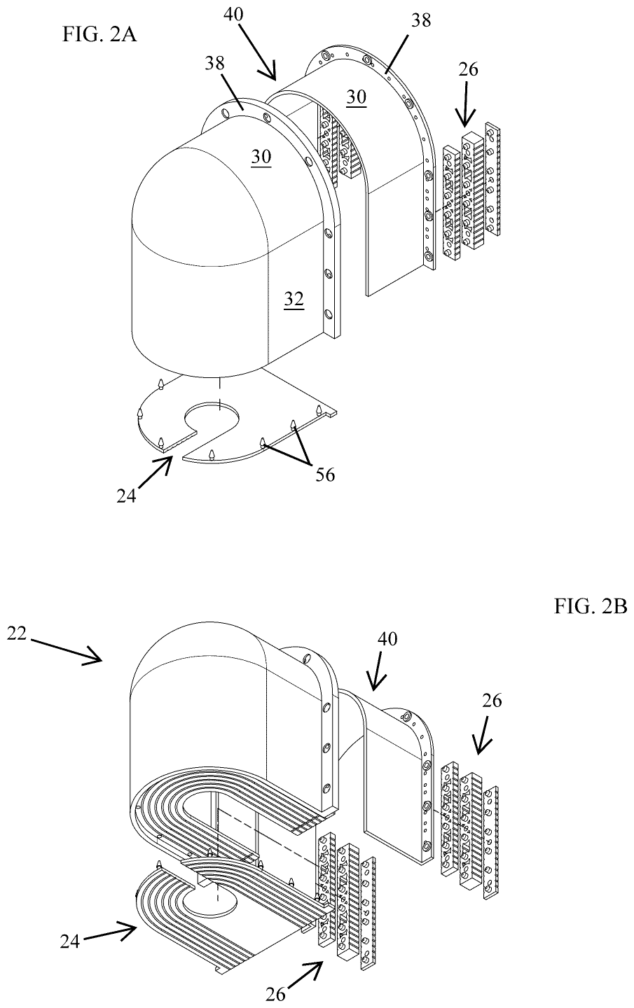

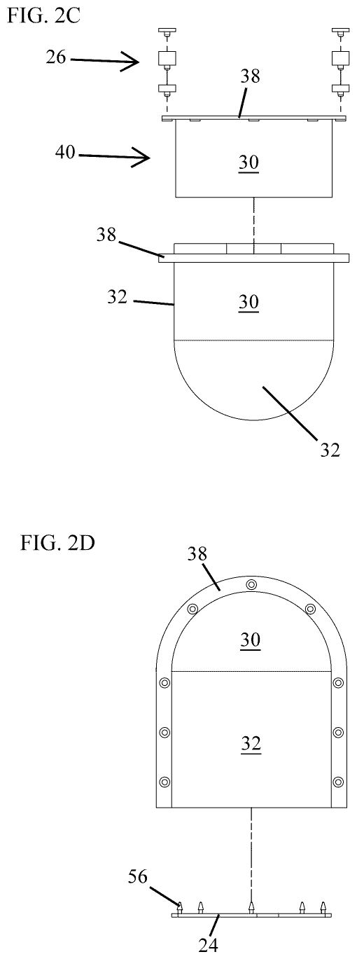

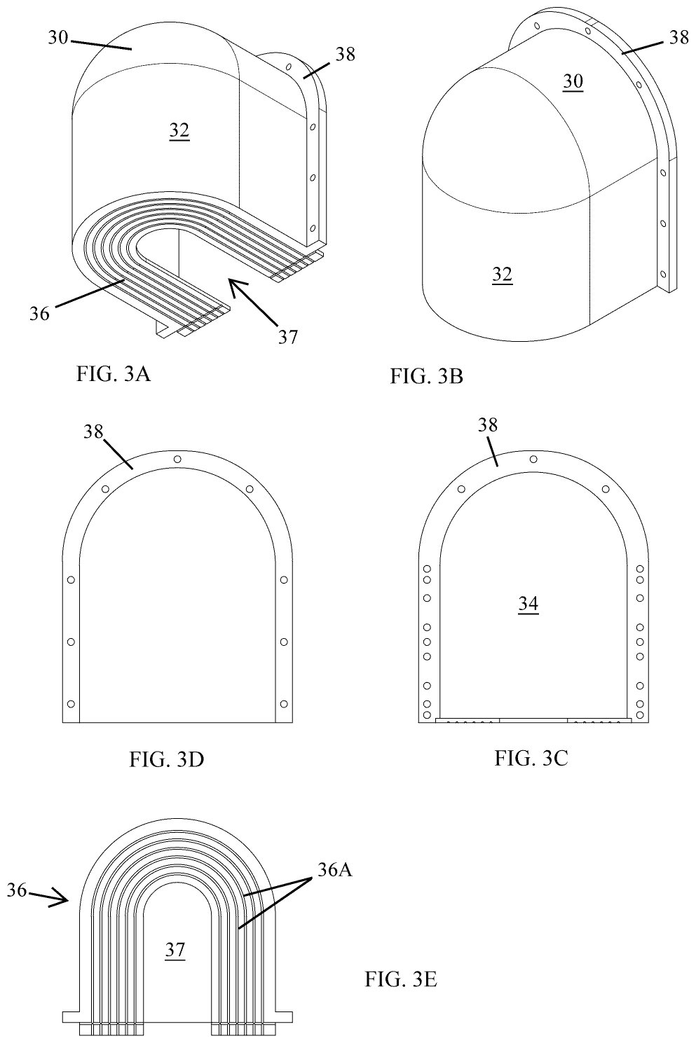

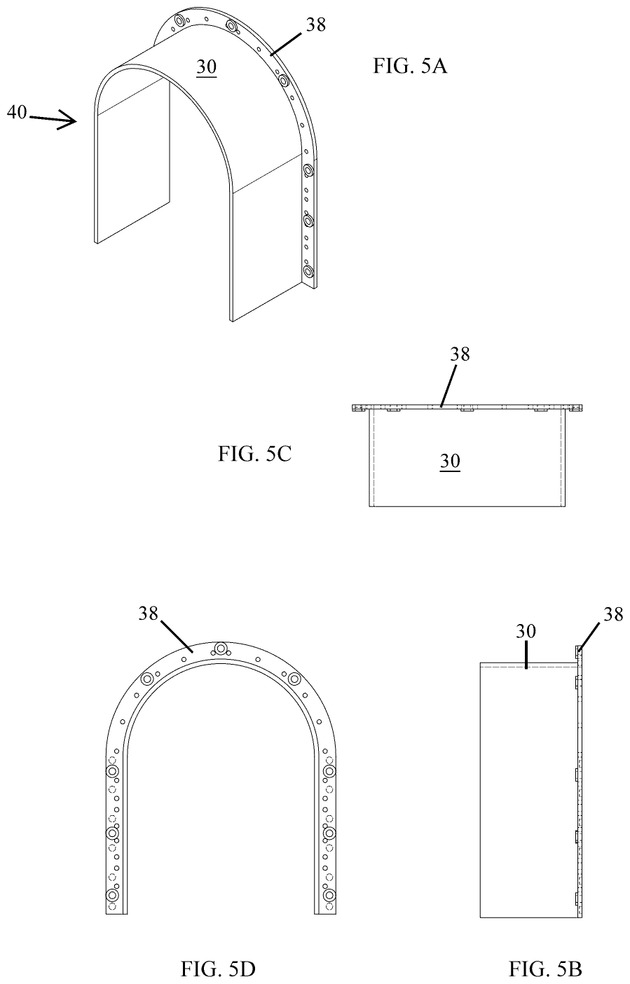

The side wall seal is shown in FIGS. 1-8. Referring, for example, to FIGS. 1A-1E, the seal 20 includes a cover 22, a bottom cover 24 and spacers 26. Referring, for example, to FIGS. 3A-3E, the cover 22 is generally bell shaped and includes a top wall 30, side wall 32, an open back 34 and bottom wall 36 having an opening 37. Bottom wall 36 includes weakened portions 36A for removal by cutting to size the opening 37 to the size of the pipe or pipes being covered and exiting through opening 37. There is a flange 38 extending outwardly from the top and side walls for attaching the cover to a side wall of a building. The cover 22 is molded. Referring, for example, to FIGS. 2A-2D and 5A-5D, the cover includes a frame 40 made of a rigid plastic such as polypropylene. The frame 40 is overmolded with a thermoplastic elastomer such as Santoprene® covering the frame and forming the remainder of the cover 22. The portion of the cover 22 with the frame 40 provides support to the cover, including when attaching to a side wall of a building. The remainder of the cover is somewhat flexible for covering a pipe or pipes extending from the building.

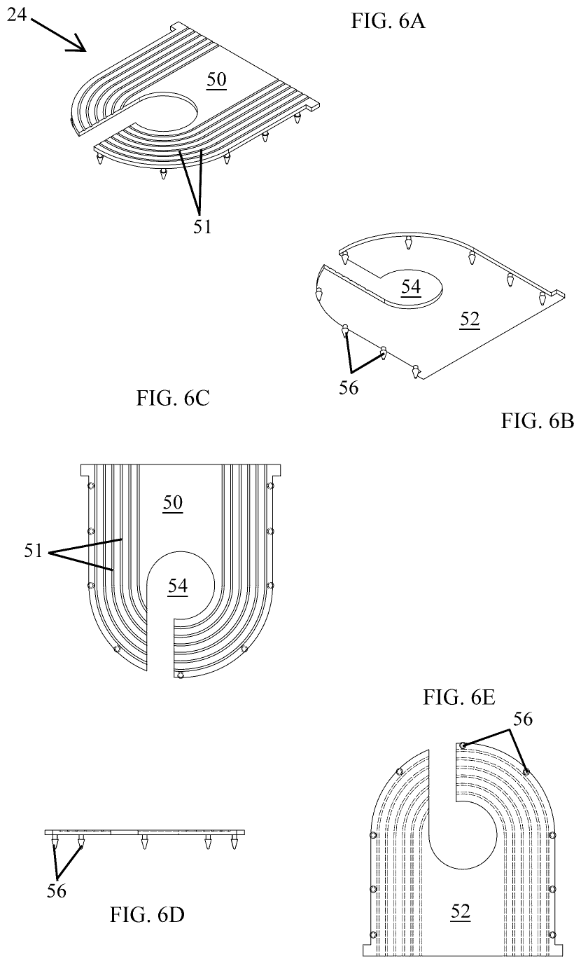

Referring, for example, to FIGS. 2A-2D and 6A-6E, the side wall seal 20 may further include a bottom cover 24 for attachment to the bottom of cover 22 to further enclose the pipe or pipes. The bottom cover 24 includes a bottom wall 50, a top wall 52 and an opening 54 through which the pipe or pipes exit. There are posts 56 for attaching the bottom cover 24 to the cover 22 by snap fit or the like in corresponding apertures of bottom wall 36. Bottom cover 24 further includes weakened portions 51 which may correspond to the weakened portions 36A of the bottom wall 36 for cutting to adjust the size of the opening 54 depending on the size of the pipe(s) exiting the cover 22.

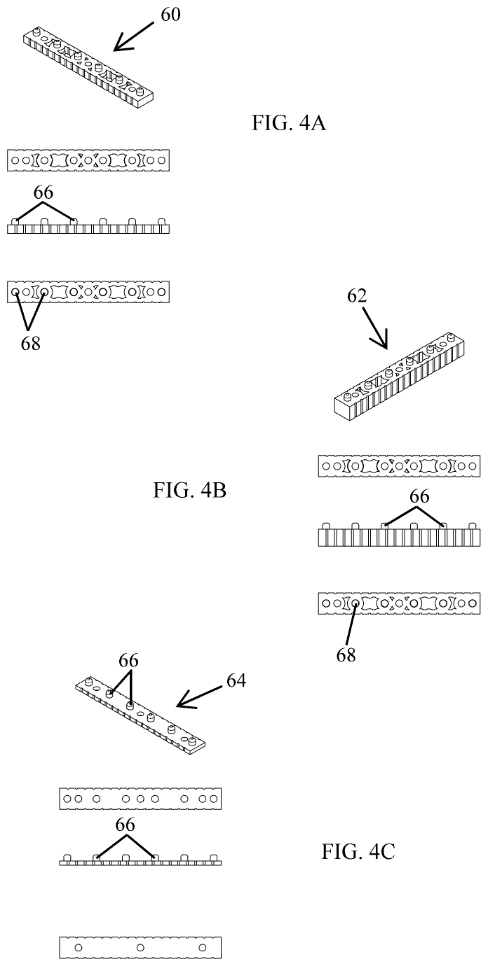

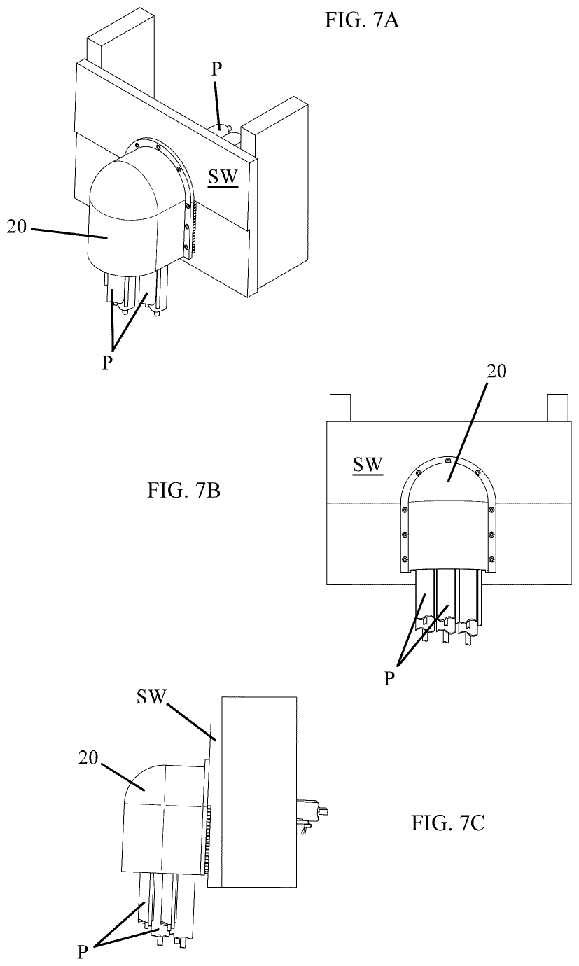

Referring to FIGS. 7A-7C, there is shown a building side wall SW having lap siding and having an uneven vertical surface. In such instances, spacers 26 may be used to provide an even vertical surface for attaching the cover 20 to the building side wall SW. Referring to FIGS. 4A-4C, three different size spacers may be used. The number and size of the spacers will depend upon the surface of the building side wall. A first spacer 60 is shown in FIG. 4A, a second spacer 62 shown in FIG. 4B and a third spacer 64 shown in FIG. 4C. The spacers include posts 66 to be inserted into corresponding apertures 68 of the cover 20 or another spacer.

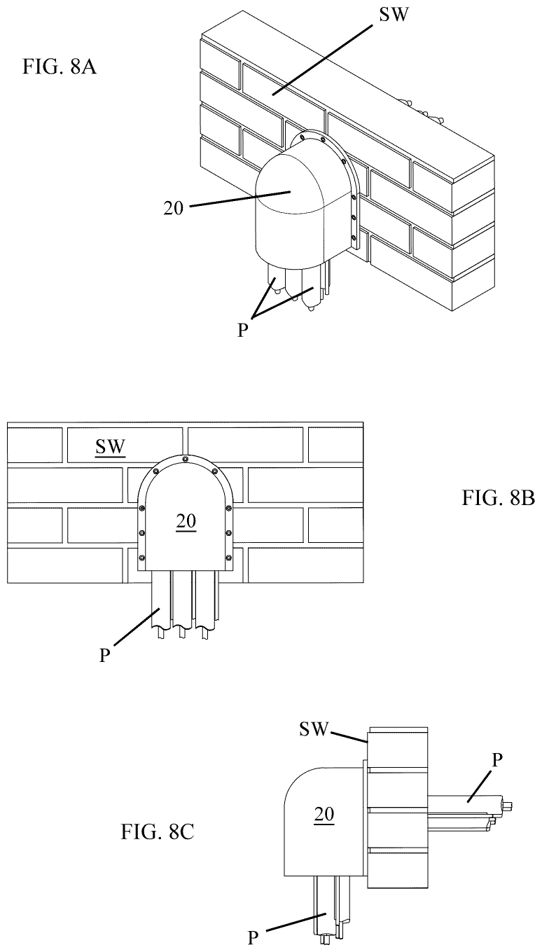

FIGS. 8A-8C show the side wall seal 20 attached to a building side wall having a flat or even surface and spacers 26 are not required.

In use, a building side wall SW is shown in FIGS. 7 and 8 and have pipes P exiting the side wall at a 90 degree angle. The pipes P are required to be covered and kept from the outside elements. In use, the side wall seal 20 is placed over the pipes and flange 38 is attached to the building side wall SW. Prior to such attachment, the bottom wall 36 of cover 22 is cut at weakened portions 36A to size the cover to the size of the pipes P to allow the pipes P to exit the bottom wall 36 of the cover 22. Similarly, if a bottom cover 24 is used, the bottom cover is cut in the same manner to allow the pipes to exit the cover. As noted above, if the building side wall has an uneven surface such as shown in FIG. 7, one or more spacers 26 are utilized to make the surface generally vertical. The cover 22 is attached to the building side wall SW by fasteners such as screws through apertures in the flange 38 of the cover 22. When spacers 26 are used, the spacers include corresponding apertures to those of the flange 38 through which the fasteners extend.

The exemplary embodiments herein disclosed are not intended to be exhaustive or to unnecessarily limit the scope of the invention. The exemplary embodiments were chosen and described in order to explain the principles of the present invention so that others skilled in the art may practice the invention. As will be apparent to one skilled in the art, various modifications can be made within the scope of the aforesaid description. Such modifications being within the ability of one skilled in the art form a part of the present invention and are embraced by the appended claims.

1. A side wall seal for piping for pipes exiting a building comprising a cover having a top wall, side wall, bottom wall and back wall, the back wall having an opening adapted to receive the pipes, the cover comprising a frame of rigid plastic overmolded with a thermoplastic elastomer, wherein the cover is adapted to attach to the building and cover the pipes.

2. The side wall seal of claim 1 wherein the cover is adapted to receive the pipes exiting the side wall of a building at a right angle.

3. The side wall seal of claim 1 wherein the cover is bell-shaped.

4. The side wall seal of claim 1 wherein the bottom wall includes an opening and means to adjust the size of the opening.

5. The side wall seal of claim 1 further comprising a bottom cover adapted to be attached to the bottom wall of the cover.

6. The side wall seal of claim 4 wherein the bottom cover is made of plastic.

7. The side wall seal of claim 6 wherein the bottom cover includes an opening and a means to adjust the size of the opening.

8. The side wall seal of claim 1 further comprising one or more spacers adapted to attach to the cover and the building.

9. The side wall seal of claim 8 wherein the spacers are made of plastic.

10. The side wall seal of claim 1 wherein the cover further comprises a flange at the back wall having apertures for attaching the flange to the building.

11. A side wall seal for piping for pipes exiting a building side wall at a right angle comprising
a cover having a top wall, side wall, bottom wall and back wall, the back wall having an opening adapted to receive the pipes, the cover comprising a frame of rigid plastic overmolded with a thermoplastic elastomer, wherein the cover is adapted to attach to the building and cover the pipes; and
a plastic bottom cover adapted to be attached to the bottom wall of the cover.

12. The side wall seal of claim 11 wherein the cover is bell-shaped.

13. The side wall seal of claim 11 wherein the bottom wall includes an opening and means to adjust the size of the opening.

14. The side wall seal of claim 11 wherein the bottom cover includes an opening and a means to adjust the size of the opening.

15. The side wall seal of claim 11 further comprising one or more plastic spacers adapted to attach to the cover and the building.

16. The side wall seal of claim 11 wherein the cover further comprises a flange at the back wall having apertures for attaching the flange to the building.
